(19) United States
(12) Patent Application Publication
(10) Pub. No.: US 2008/0224644 A1
(43) Pub. Date: Sep. 18, 2008

(54) METHOD CAPABLE OF CONTROLLING INITIAL CURRENT FOR DRIVING A MOTOR

(76) Inventors: JAO-CHING LIN, Taipei (TW); Lin-Abel Chu, Taipei (TW); You-Kang Lin, Taipei (TW); Cheng-Chung Tsau, Taipei (TW); Chung-Yi Shen, Taipei (TW)

Correspondence Address: G. LINK CO., LTD., 3550 BELL ROAD, MINOOKA, IL, 60447, US

(21) Appl. No.: 11/685,631

(22) Filed: Mar. 13, 2007

(51) Int. Cl. H02P 23/00

(52) U.S. Cl. 318/494

(57) ABSTRACT

A method capable of controlling initial current value for driving a motor includes following steps: (a) an output reference level of a driving unit being connected to a motor coil set to operate a motor constituted with the motor coil set; (b) a magnetic pole change being detected with a sensing unit during the motor being in operation and an output signal being produced by the sensing unit; (c) determining if the motor is in a state of operation by means of whether a control unit receives the output signal or not; and (d) the control unit restricting the reference level of the driving unit being output to the motor coil set while the output signal of the sensing unit is received by the control unit.

### BACKGROUND OF THE INVENTION

1. Field of the Invention

The present invention is related to a method for controlling initial current value for driving a motor and particularly to a method capable of restricting driving reference level of a motor at the time of the motor starting running to avoid useless power consumption.

2. Brief Description of the Related Art

The conventional art usually employs pulse width modulation signal (PWM) to control conducting time of the coil set in a cooling fan motor so as to control rotation of the cooling fan motor. Further, different rotational speeds can be controlled in accordance with different duty cycles of the PWM signal. However, amplitude, frequency and duty cycle of the PWM are variables to affect the rotational speed of the fan motor.

Besides, referring to FIG. 1, the first conventional circuit is illustrated. The first conventional circuit includes a reverse voltage protective diode 101, a Hall component 102, a driving component 103, a first transistor 104, a second transistor 105, a first resistance 106, a second resistance 107, a third resistance 108 with a first motor coil set 109, a second motor coil set 120, a fourth resistance 124, a fifth resistance 122, a third transistor 123 and a fourth transistor 124. The Hall component 102, the driving component 103, the first transistor 104, the second transistor 105, the first resistance 106, the second resistance 107, the third resistance 108, the first motor coil set 109 and the second motor coil set 120 constitute driving circuit 10.

When the power is conducted to the circuit via the reverse voltage protective diode 101, the Hall component 102 of the driving circuit 10 detects the magnetic pole change of the rotor to produce positive voltage H+ and negative voltage H− outputting to the driving component 103. The driving component 103 transforms the preceding voltages as control signal source being output to the first transistor 104 and the second transistor 105 via the first output end OUT1 and the second output end OUT2 respectively. A PWM signal from PWM input end passes through the fourth resistance 121, the fifth resistance 122 and both collectors of the third transistor 123 and fourth transistor 124 to cut off control signal sources of the first output end OUT1 and the second output end OUT2 such that the first motor coil set 109 and the second motor coil set 120, which are connected to collectors of the first transistor 104 and the second transistor 105 respectively, are controlled for controlling the rotational speed of the fan motor.

Referring to FIG. 2, the second conventional circuit is illustrated. The second conventional circuit includes a reverse voltage protective diode 201, a Hall component 202, a driving component 203, a first transistor 204, a second transistor 205, a first resistance 206, a second resistance 207, a third resistance 208, a first motor coil set 209, a second motor coil set 220, a fourth resistance 221 and a third transistor 222. The Hall component 202, the driving component 203, the first transistor 204, the second transistor 205, the first resistance 206, the second resistance 207, the third resistance 208, the first motor coil set 209 and the second motor coil set 220 constitute driving circuit 20. A PWM signal from a PWM input end is connected to a control input end ST of the driving component 203 via the fourth resistance 221 and the third transistor 222 such that the driving circuit 20 is controlled to produce switch actuating time by means of the duty cycle of the PWM signal being changed in accordance with periodic change of PWM signal. As a result, power of the first motor coil set 218 and the second motor coil set 219 can be controlled for controlling the rotational speed of the fan motor.

Referring to FIG. 3, the third conventional circuit is illustrated. The third conventional circuit includes is composed of a reverse voltage protective diode 301, a Hall component 302, a driving component 303, a first transistor 304, a second transistor 305, a first resistance 306, a second resistance 307, a third resistance 308, a first motor coil set 309 and a second motor coil set 320. The PWM signal from a PWM input end passes through the fourth resistance 321 and the third transistor 322 to control “On” and “Off” of the power source such that the first motor coil set 309 and the second motor coil set 320, which are connected to collectors of the first transistor 304 and the second transistor 305 respectively, are controlled for controlling the rotational speed of the fan motor.

The preceding prior art needs extremely large current for starting the motor and the starting current usually is 2 to 3 times of the normal operation current as shown in FIG. 4. The too much greater starting current results in useless power consumption or, even more, damage of driving components. Alternatively, in order to overcome deficiency of the starting current damaging the driving components, the starting current is reduced to a level of being slightly higher or less than the normal operation current such as being 0.8 time of the normal operation current as shown in FIG. 5. However, the reduced starting current not only is incapable of solving the problem of useless power consumption but also creates a disadvantage of shortening life span of the motor system.

### SUMMARY OF THE INVENTION

In order to improve the preceding problems, an object of the present invention is to provide a method capable of controlling initial current level for driving a motor with which excessive starting current passing through the motor coil set is avoidable by means of sensing unit detecting the motor at the time of staring and output level of the driving unit being limited.

Another object of the present invention is to provide a method capable of controlling initial current value for driving a motor with which the output level of the driving unit is restricted to prevent the driving component from being damaged due to excessive starting current passing through the motor coil set.

Accordingly, a method capable of controlling initial current value for driving a motor according to the present invention includes following steps: (a) an output level of a driving unit being sent to a motor coil set to operate a motor constituted with the motor coil set; (b) magnetic pole change being detected with a sensing unit during the motor being in operation and an output signal being produced by the sensing unit; (c) determining if the motor is in a state of operation by means of whether a control unit receives the output signal or not; and (d) the control unit limiting the output level of the driving unit to the motor coil set while the output signal of the sensing unit is received by the control unit.

### BRIEF DESCRIPTION OF THE DRAWINGS

The detail structure, the applied principle, the function and the effectiveness of the present invention can be more fully understood with reference to the following description and accompanying drawings, in which:

FIG. 1 is the first type conventional circuit diagram;

FIG. 2 is the second type conventional circuit diagram;

FIG. 3 is the third type conventional circuit diagram;

FIGS. 4 and 5 are graphs illustrating current curves of the motor coil set shown in FIGS. 1 to 3;

FIG. 6 is a block diagram of a preferred embodiment of a method for controlling initial driving current level of a motor according to the present invention;

FIG. 7 is a flow chart illustrating the preferred embodiment of a method for controlling initial driving current level of a motor according to the present invention; and

FIG. 8 is a graph illustrating the current curve of the motor coil set shown in FIG. 6.

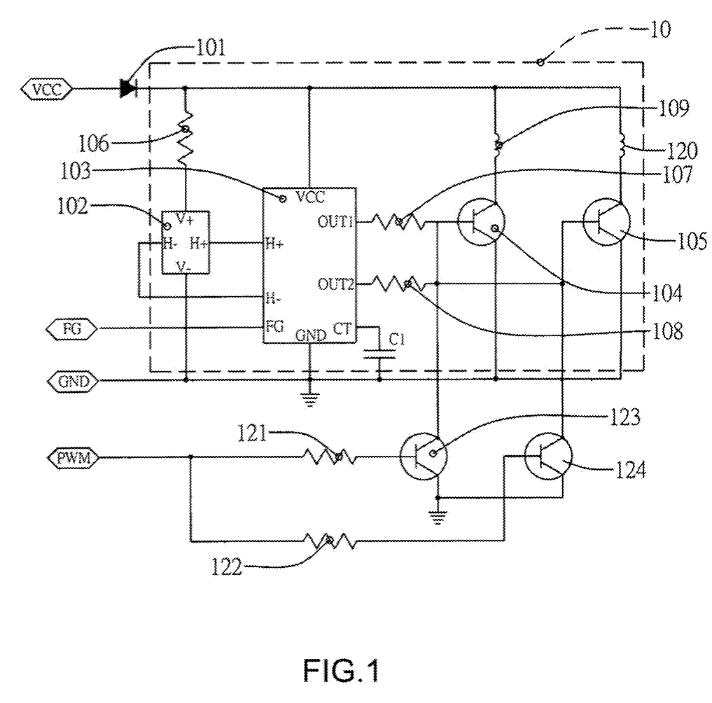

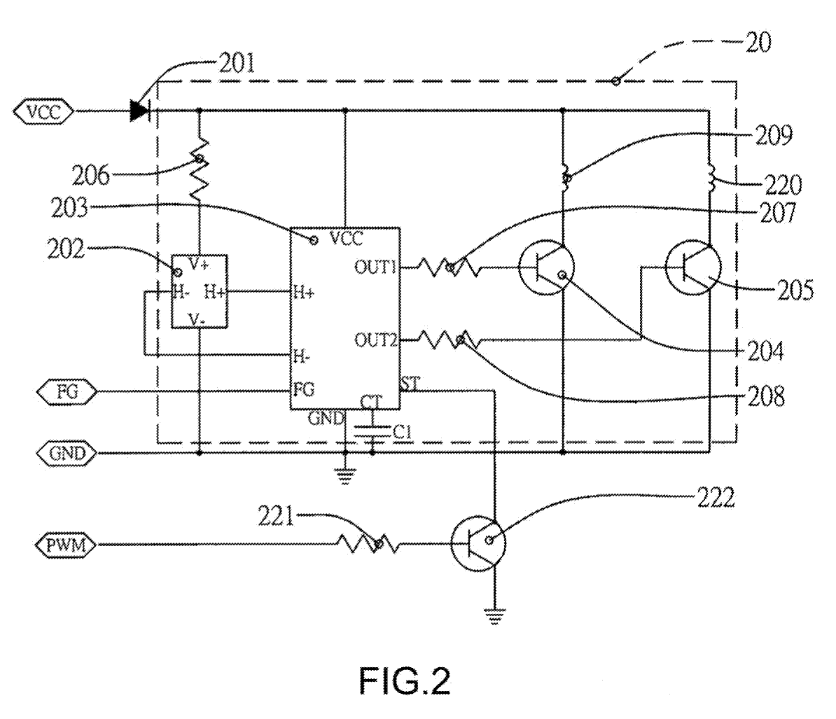

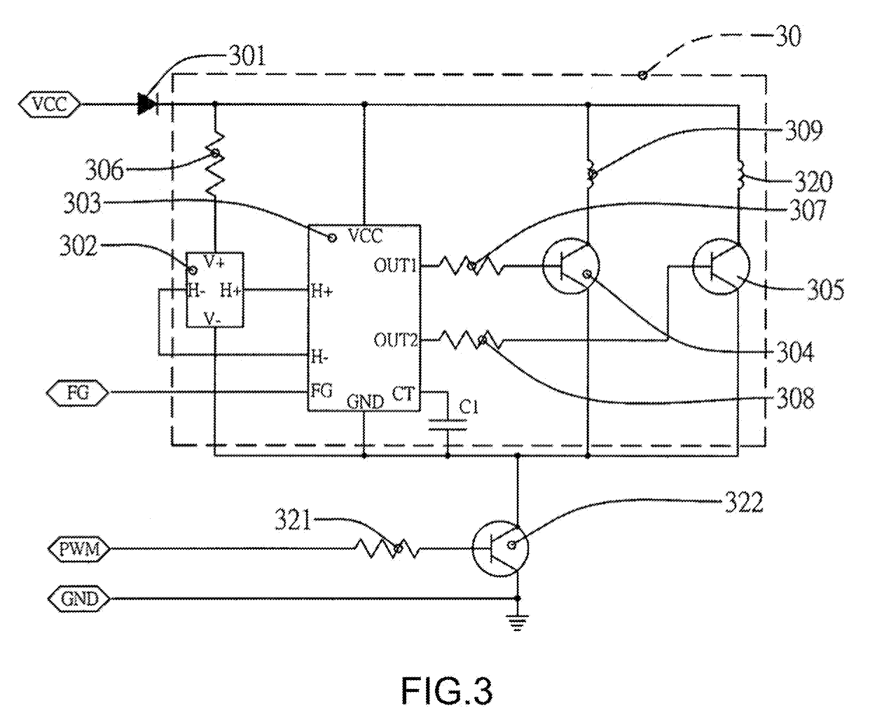

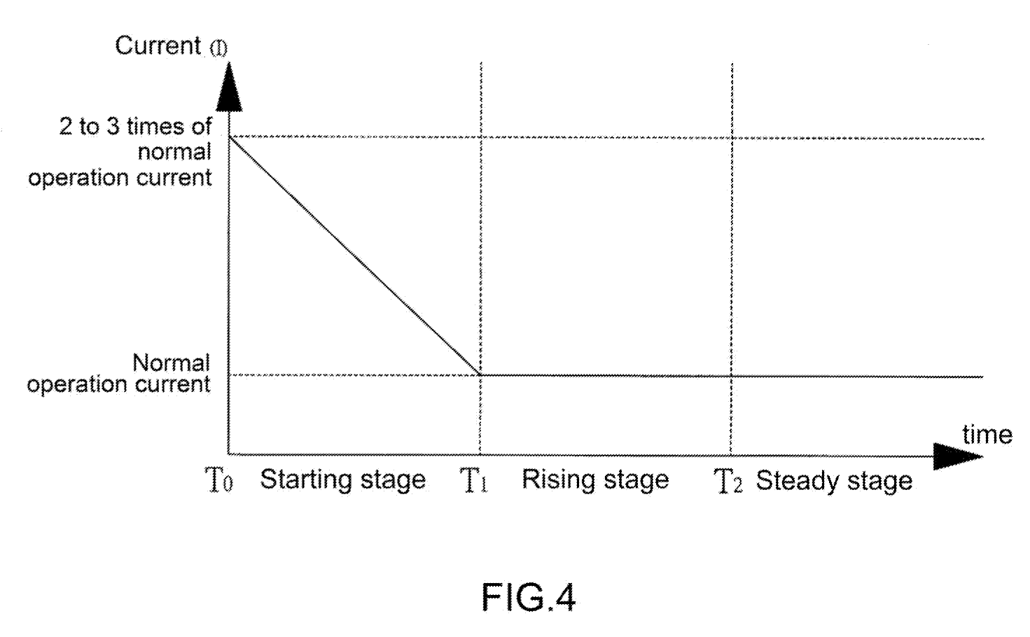

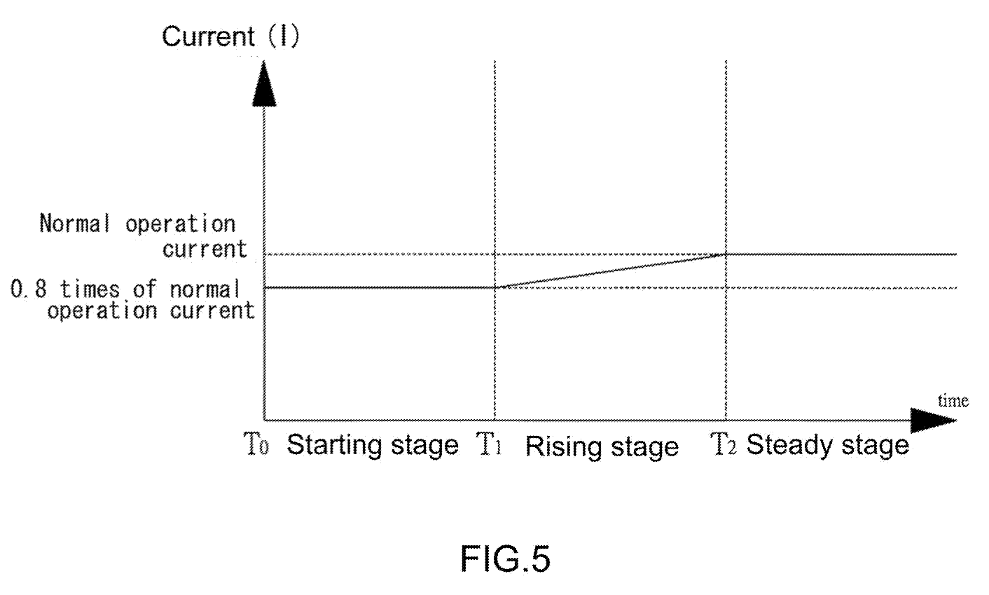

### DETAILED DESCRIPTION OF THE INVENTION

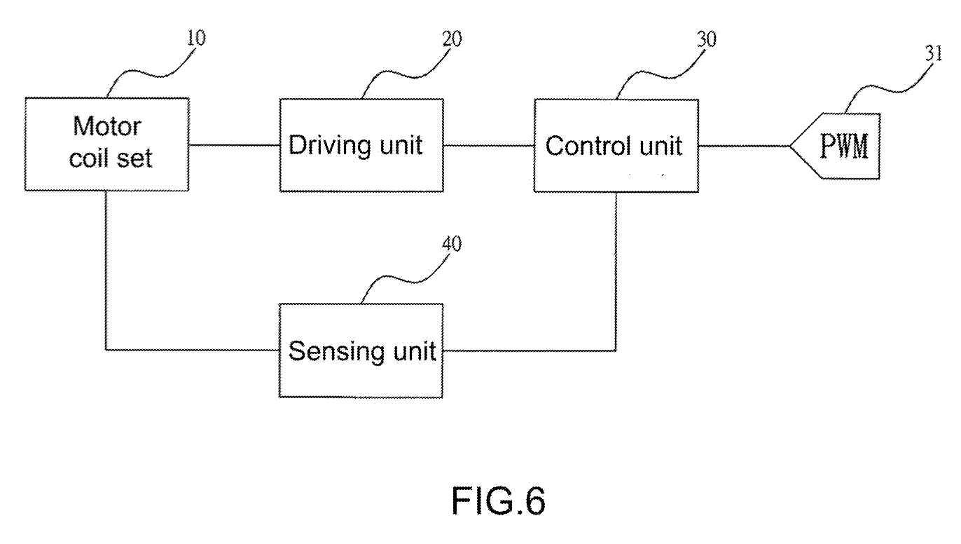

Referring to FIG. 6, a preferred embodiment of a method for controlling initial driving current of a motor according to the present invention includes a motor coil set 10, a driving unit 20, which is connected to the motor coil set 10 and outputs a reference value to operate the motor (not shown) constituted by the motor coil set 10, and a control unit 30, which is connected to the driving unit 20 to control the output level. The control unit 30 further provides a pulse width modulation input end 31 (abbreviated as PWM end 31 hereinafter) to offer a PWM input signal or the control unit 30 itself generates a PWM signal such that the control unit 30 is capable of controlling the output level to actuate the motor during duty cycle of the PWM signal.

A sensing unit 40, which is disposed next to the motor and the control unit 30, can be such as Hall component to sense magnetic pole change so as to generate output signal to the control unit 30. Hence, the current level passing through the motor coil set 10 can be controlled by means of the control unit 30 maintaining the output level of the driving unit 20.

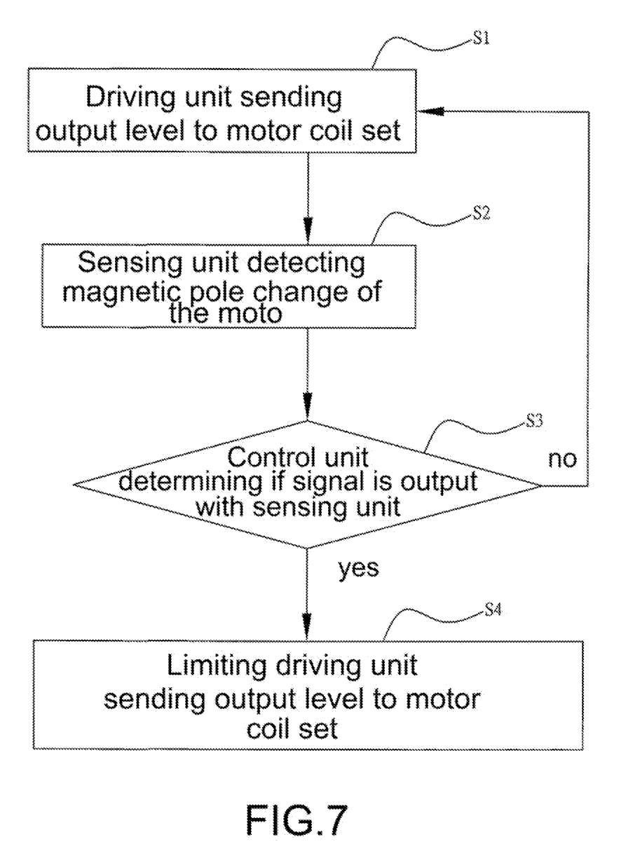

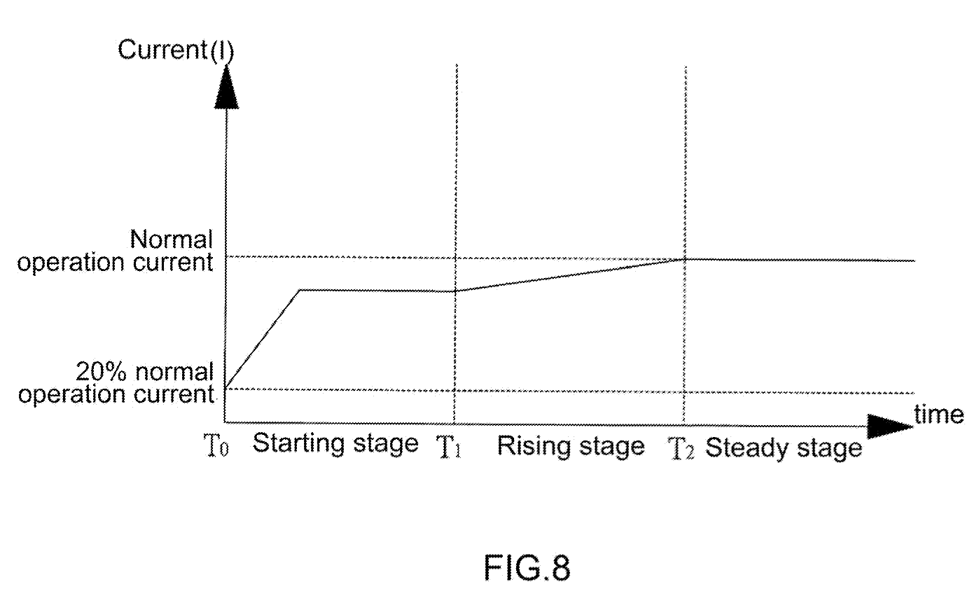

Therefore, referring to FIG. 7, the method for controlling initial current value of a motor includes following steps. Step S1 is the output level of the driving unit 20 is sent to the motor coil set 10 to operate the motor. It can be seen in FIG. 8 that the duty cycle of the PWM signal is divided into starting stage, rising stage and steady stage and the output reference level of the driving unit 20 corresponding to the different stages is illustrated. The output level of the driving unit 20 at the starting stage is much less than the preceding conventional art. For instance, the starting current passing through the motor coil set 10 is 20% less than normal operation current explanatorily shown in FIG. 8. Due to the output level being extremely small at the starting stage of the duty cycle, excessive starting current to damage both of the driving component and the motor system is avoidable. Step S2 is to produce output signal by means of the sensing unit 40 for detecting the magnetic pole change during the motor being in operation. Step S3 is to determine if the motor is in a state of operation based on if the control unit 30 receives the signal from the sensing unit 40. The control unit 30 further decides if the output reference level sent to motor coil set 10 has to be restricted. In other words, the control unit 30 instructs the driving unit 20 to continue sending the output reference level to the motor coil set 10 until the signal from the sensing unit 40 is received by the control unit 30. Once the control unit 30 receives the signal from the sensing unit 40, it means the motor constituted by the coil set 10 begins to run and the current passing through the motor coil set 10 is the initial current value.

Step S4 is that the control unit 30 instructs the driving unit 20 to keep the initial current value being sent to the motor coil set 10 at the staring stage. In this way, deficiency of the current passing through the motor coil set 10 during the duty cycle of the PWM signal continuously rising or being much greater than the normal operation current to result in power useless consumption can be overcome completely.

While the invention has been described with referencing to preferred embodiments thereof, it is to be understood that modifications or variations may be easily made without departing from the spirit of this invention, which is defined by the appended claims.

What is claimed is:

1. A method capable of controlling initial current value for driving a motor, comprising following steps:
(a) an output reference level of a driving unit being connected to a motor coil set to operate a motor constituted with the motor coil set;
(b) a magnetic pole change being detected with a sensing unit during the motor being in operation and an output signal being produced by the sensing unit;
(c) determining if the motor is in a state of operation by means of whether a control unit receives the output signal or not; and
(d) the control unit restricting the reference level of the driving unit being output to the motor coil set while the output signal of the sensing unit is received by the control unit.

2. The method capable of controlling initial current value for driving a motor as defined in claim 1, wherein the control unit in the step (c) provides a pulse width modulation (PWM) input end for inputting PWM signal for the control unit capable of controlling the output reference level of the driving unit during duty cycle of the PWM signal.
